(19) United States
(12) Patent Application Publication
(10) Pub. No.: US 2026/0106244 A1
(43) Pub. Date: Apr. 16, 2026

(54) BATTERY PROCESSING METHOD AND BATTERY PROCESSING SYSTEM

(71) Applicant: MAZDA MOTOR CORPORATION, Hiroshima (JP)

(72) Inventors: Susumu MINEOI, Aki-gun (JP); Tenyu YAN, Aki-gun (JP); Kenjiro MOMOSAKI, Aki-gun (JP); Tomoki YAMAMOTO, Aki-gun (JP)

(73) Assignee: MAZDA MOTOR CORPORATION, Hiroshima (JP)

(21) Appl. No.: 19/335,047

(22) Filed: Sep. 22, 2025

(30) Foreign Application Priority Data
Oct. 11, 2024 (JP) 2024-179282

(51) Int. Cl. H01M 10/44; H01M 4/38; H01M 10/0525; H01M 10/54

(52) U.S. Cl. CPC H01M 10/445; H01M 4/382; H01M 10/0525; H01M 10/54

(57) ABSTRACT

A battery processing method for processing a lithium-ion battery including a positive electrode material and a negative electrode material and configured by laminating the positive electrode material and the negative electrode material in a lamination direction. The battery processing method includes: a structure change step of charging/discharging the lithium-ion battery to cause a structure change of a surface of a negative electrode active material; and a lithium deposition step of charging/discharging the lithium-ion battery to deposit lithium on the negative electrode material.

### CROSS-REFERENCE TO RELATED APPLICATION

The present application claims priority to Japanese Patent Application 2024-179282, filed Oct. 11, 2024, the entire contents of which are incorporated herein by reference.

### FIELD

Embodiments relate to a battery processing method and a battery processing system.

### BACKGROUND

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

Patent Literature 1 discloses a method for increasing an amount of lithium contained in a positive electrode material by discharging the used lithium-ion battery to collect lithium from the positive electrode material.

### CITATION LIST

### Patent Literature

[Patent Literature 1] JP-A-2022-049831

### SUMMARY

The positive electrode material is generally configured by forming a positive electrode active material on a current collector foil such as aluminum. For example, in a case of a ternary system (NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide a battery processing method and a battery processing system capable of efficiently collecting lithium from a lithium-ion battery.

One or more embodiments may provide
a battery processing method for processing a lithium-ion battery including a positive electrode material and a negative electrode material and configured by laminating the positive electrode material and the negative electrode material in a lamination direction, the battery processing method including:
a structure change step of charging/discharging the lithium-ion battery to cause a structure change of a surface of a negative electrode active material; and
a lithium deposition step of charging/discharging the lithium-ion battery to deposit lithium on the negative electrode material.

One or more embodiments may provide
a battery processing system for processing a lithium-ion battery including a positive electrode material and a negative electrode material, the battery processing system including:
a pressing device that presses at least a portion of the lithium-ion battery; and a charging/discharging device that charges/discharges the lithium-ion battery.

### Advantageous Effects

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to a first embodiment.

FIG. 2 is a perspective view illustrating a schematic configuration of a lithium-ion battery.

FIG. 3 is a cross-sectional view illustrating a schematic configuration of a battery cell.

FIG. 4 is a flowchart schematically illustrating a flow of reuse of the lithium-ion battery.

FIG. 5 is a graph illustrating a relationship between a charging rate and ease of deposition of lithium with respect to SOC at each cooling temperature.

FIG. 6 is a graph schematically illustrating pulse charging.

FIG. 7 is a block diagram schematically illustrating a reuse system according to a third embodiment.

FIG. 8 is a view illustrating a schematic configuration of a pressing device.

FIG. 9 is a flowchart schematically illustrating a flow of reuse according to a fourth embodiment.

FIG. 10A is a view schematically illustrating an example of operation of the pressing device.

FIG. 10B is a view schematically illustrating the example of the operation of the pressing device following FIG. 8A.

FIG. 11A is a view schematically illustrating another example of the operation of the pressing device.

FIG. 11B is a view schematically illustrating the other example of the operation of the pressing device following FIG. 9A.

FIG. 11C is a view schematically illustrating the other example of the operation of the pressing device following FIG. 9B.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment is
a battery processing method for processing a lithium-ion battery including a positive electrode material and a negative electrode material and configured by laminating the positive electrode material and the negative electrode material in a lamination direction, the battery processing method including:
a lithium deposition step of charging the lithium-ion battery to deposit lithium on the negative electrode material;
a battery disassembly step of disassembling at least the negative electrode material from the lithium-ion battery; and
a lithium extraction step of extracting lithium from the negative electrode material.

### First Embodiment

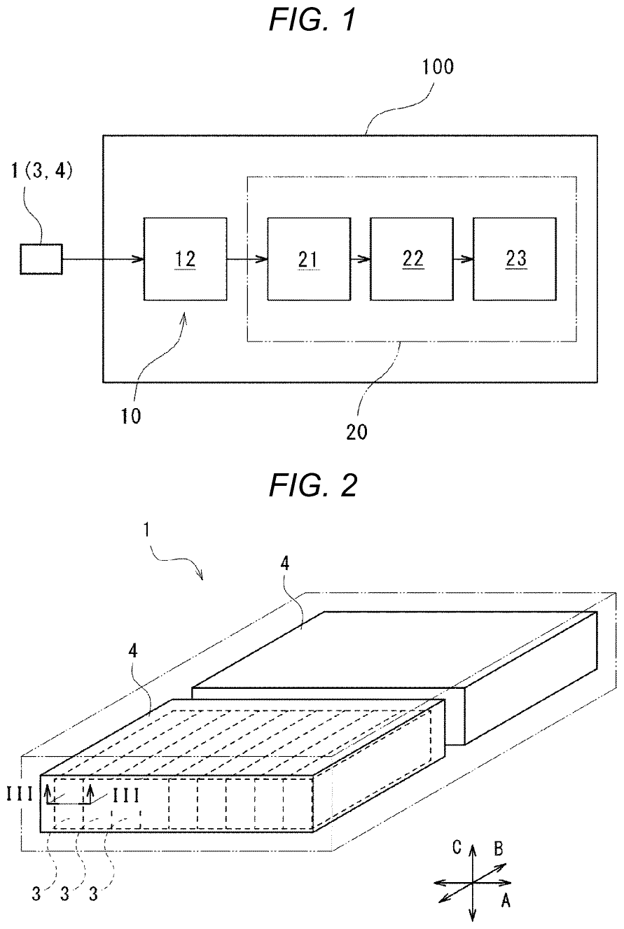

Hereinafter, a reuse system of a lithium-ion battery according to a first embodiment will be described with reference to the accompanying drawings. FIG. 1 is a block diagram schematically illustrating a reuse system 100 of a lithium-ion battery 1. As illustrated in FIG. 1, the reuse system 100 includes: a reuse unit 10 secondarily using the lithium-ion battery 1 that has been used primarily in an electric-powered vehicle, for example; and a recycle unit 20 collecting lithium from the lithium-ion battery 1 that has been used secondarily.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, it is removed from the vehicle, and is used, in the reuse unit 10, as the electrical storage device for any of various secondary applications, such as a storage of renewable energy including solar power and wind power and a backup power source in the event of a disaster. For example, when the SOH becomes 70% or less, it may be determined to be inappropriate for the primary use, that is, for use in the electric-powered vehicle.

The reuse unit 10 includes the lithium-ion battery 1, which is used secondarily as the electrical storage device, and a charging device 12. The charging device 12 is configured to be able to charge the lithium-ion battery 1 in any appropriate charging pattern by adjusting a voltage and a current. For example, the lithium-ion battery 1 can be charged continuously at a predetermined voltage and a predetermined current, and can also be charged intermittently at the predetermined voltage and the predetermined current (also referred to as pulse charging). An upper limit of the charging voltage by the charging device 12 is a withstand voltage of the lithium-ion battery 1 or less, and is 4.3 V or less, for example.

The reuse unit 10 further includes a cooling device 201 capable of cooling the lithium-ion battery 1. The cooling device 201 may be a suitable cooling device of any appropriate type. In the present embodiment, a thermostatic bath is adopted as the cooling device 201. For example, the cooling device 201 may be configured as a cooling chamber, inside of which can be cooled, and the lithium-ion battery 1 may be cooled by accommodating the lithium-ion battery 1 in the cooling chamber.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for the secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on the electric-powered vehicle. The lithium-ion battery 1 constitutes a battery pack having battery modules 4, each of which incorporates functions as a charge/discharge circuit, a cooling mechanism, and the like. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

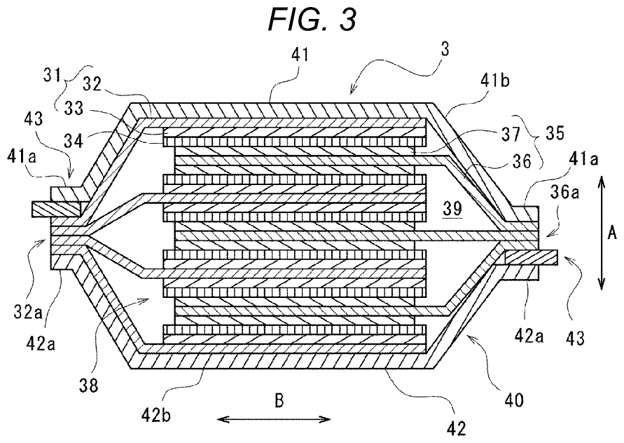

FIG. 3 is a cross-sectional view schematically illustrating the battery cell 3. As illustrated in FIG. 3, the battery cell 3 according to the present embodiment is of a laminated type (stacked type). The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The laminated electrode body 38 includes a positive electrode current collector end portion 32a, in which plural positive electrode current collectors 32 are connected, in one end portion (a left side in FIG. 3) in a width direction B (a left-right direction in FIG. 3) orthogonal to the lamination direction A, and includes a negative electrode current collector end portion 36a, in which plural negative electrode current collectors 36 are connected, in the other end portion (a right side in FIG. 3). The battery cell 3 has a rectangular shape that is thin and long in the width direction B when viewed in the lamination direction A.

The positive electrode material 31 includes a positive electrode current collector 32 and a positive electrode active material 33 that is laminated on a surface of the positive electrode current collector 32 facing the separator 34. In the positive electrode current collector end portion 32a, the plural positive electrode current collectors 32 are connected to each other in the one end portion (the left side in FIG. 3) in the width direction B that is orthogonal to the lamination direction. A metal foil suitable for a positive electrode can be suitably used for each of the positive electrode current collectors 32. A material that is used as a positive electrode active material of the lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is laminated on a surface of the negative electrode current collector 36 facing the separator 34. In the negative electrode current collector end portion 36a, the plural negative electrode current collectors 36 are connected to each other in the other end portion (the right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 includes a first case 41 and a second case 42 that are provided as a pair on both sides of the laminated electrode body 38 in the lamination direction A. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 according to an embodiment is formed by a portion, which is sandwiched by the paired flange portions 41a, 42a, in the battery cell 3.

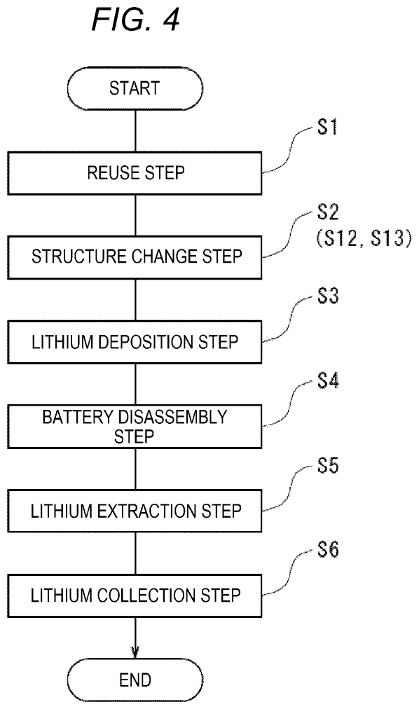

Next, reuse of the lithium-ion battery 1 will be described. FIG. 4 is a flowchart schematically illustrating a flow of reuse of the lithium-ion battery 1. As illustrated in FIG. 4, when it is determined that the lithium-ion battery 1, which is mounted on the electric-powered vehicle, is in the deteriorated state that is not suitable for use in the electric-powered vehicle on the basis of the SOH, for example, a reuse step (step S1) is executed. In the reuse step S1, the lithium-ion battery 1 is removed from the electric-powered vehicle and used secondarily in the reuse unit 10.

In a case where it is determined that the lithium-ion battery 1 is in a predetermined deteriorated state after being used secondarily as the electrical storage device, a structure change step (step S2) is executed following the secondary use in the reuse unit 10. In the structure change step S2, the lithium-ion battery 1 is charged/discharged to cause a structure change of a surface of the negative electrode active material.

In the structure change step S2, a structure of the surface of the negative electrode active material can be changed by applying the current that exceeds a rated current. The current can be 1.1 times or more, 1.5 times or more, or twice or more of the rated current, for example. In a case where a material for the negative electrode active material is graphite, for example, the change in the structure of the surface of the negative electrode active material can be that a layer structure or a honeycomb structure of a surface layer of graphite is broken. The structure change of the surface of the negative electrode active material can be detected, for example, by observing a shape change of an active material particle surface from an electrode surface by a scanning electron microscope (SEM) or a transmission electron microscope (TEM), or by observing a shape and a structure change of the active material particle surface from a cross section of an electrode by a focused ion beam processing-scanning electron microscope (FIB-SEM) or the transmission electron microscope (TEM). Meanwhile, when the negative electrode active material is graphite, it can be detected by analyzing a chemical state change of carbon atoms constituting graphite by Raman, X-ray photoelectron spectroscopy (XPS), or X-ray absorption spectroscopy (XAS, XAFS), or by analyzing a crystal structure change of graphite by X-ray diffraction (XRD) or electron diffraction.

As charging in the structure change step S2, the pulse charging for intermittent charging may be adopted. More specifically, the pulse charging in the structure change step S2 includes a charging phase, in which charging is performed to cause the structure change of the surface of the negative electrode active material, and a discharging phase, and these are repeated or performed at least two times.

The lithium deposition step (step S3) is executed. In the lithium deposition step S3, lithium is deposited on the negative electrode material 35. In the lithium deposition step S3, the lithium-ion battery 1 is charged to deposit lithium on the negative electrode material 35. Since the structure of the surface of the negative electrode active material is changed by the structure change step S2 described above, lithium is preferentially or selectively deposited on a portion whose structure has been changed. This facilitates subsequent lithium collection.

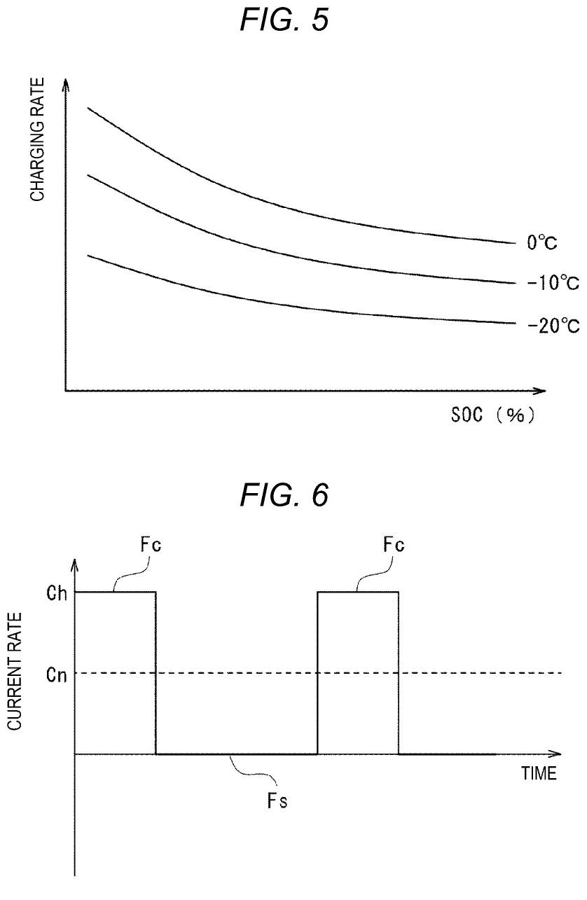

In the lithium deposition step S3, the lithium-ion battery 1 may be charged while being cooled by the cooling device 201 under a predetermined cooling condition. Here, a graph in FIG. 5 illustrates a relationship between a charging rate (a charging current), at which lithium starts being deposited, and state of charge (SOC) per temperature. More specifically, when charging is performed on a curve or in a region above the curve at each temperature, lithium is easily deposited on the negative electrode material 35. The SOC is an indicator indicating a charged state of the battery, and indicates battery capacity when a fully charge state is set as 100% and a completely discharged state is set as 0%. As illustrated in FIG. 6, lithium is more likely to be deposited as the SOC of the lithium-ion battery 1 is increased and/or as the temperature thereof is reduced.

Thus, in the lithium deposition step S3, the lithium-ion battery 1 is charged at the appropriate charging rate, at which lithium is deposited on the negative electrode material 35, for the cooling temperature. In an implementation, the lithium-ion battery 1 is charged under a charging condition with which lithium starts being deposited on the negative electrode material 35. For example, even when the charging rate is suppressed to be low, lithium can be deposited on the negative electrode material 35 by cooling the lithium-ion battery 1.

As charging in the lithium deposition step S3, the pulse charging for intermittent charging may be adopted. More specifically, as illustrated in FIG. 6, the pulse charging includes: a charging phase Fc in which charging is performed to deposit lithium; and a charging pause phase Fs in which charging is paused, and these are repeated or performed at least two times. At least the charging phase Fc is performed at least two times. Here, cooling by the cooling device 201 is performed only in the charging phase Fc and is not performed in the charging pause phase Fs.

Here, as lithium is deposited on the negative electrode material 35, lithium ions that exist in the vicinity of the negative electrode active material 37 (at least in a region adjacent to the negative electrode active material) are reduced. As a result, lithium ion concentration is reduced in the vicinity of the negative electrode active material 37. Accordingly, even when charging continues, it is difficult to effectively deposit lithium on the negative electrode material 35. Thus, according to the present embodiment, the lithium ions around the negative electrode active material 37 tend to gather in the vicinity of the negative electrode active material 37 in the pause phase Fs of the pulse charging, and a reduction in the lithium ion concentration in the vicinity of the negative electrode active material 37 can be alleviated. Therefore, lithium can be effectively deposited on the negative electrode material 35 by performing the charging phase Fc after the reduction in the lithium ion concentration is alleviated.

Next, the lithium-ion battery 1 is removed from the reuse unit 10, and a battery disassembly step (step S4) is executed by the disassembly device 21. In the battery disassembly step S4, the lithium-ion battery 1 is disassembled into components such as the positive electrode material 31, the separator 34, the negative electrode material 35, and the case 40. When only the collection of lithium is intended, at least the negative electrode material 35 may only be disassembled. The disassembly device 21 may be any appropriate device that automatically disassembles the lithium-ion battery 1. Here, the lithium-ion battery 1 may be disassembled manually by using a tool or the like without using the disassembly device 21.

Next, a lithium extraction step (step S5) is executed. In the lithium extraction step S5, lithium is extracted from the disassembled negative electrode material 35. In the lithium extraction step S5, after the negative electrode material 35 is exuded with water, which is then filtered, the extraction device 22 removes the negative electrode current collector 36 and the negative electrode active material 37 from the negative electrode material 35, and thereby extracts an aqueous solution containing the lithium ions.

Finally, a lithium collection step (step S5) is executed. In the lithium collection step S5, lithium is collected from the aqueous solution containing the lithium ions. In the lithium collection step S5, after subjecting lithium to a solution treatment with carbonated water, the collection device 23 filters the solution and collects lithium as or in the form of lithium carbonate.

That is, the battery processing method according to the present embodiment is
the battery processing method for processing the lithium-ion battery including the positive electrode material and the negative electrode material, the battery processing method including:
the structure change step of charging/discharging the lithium-ion battery to cause the structure change of the surface of the negative electrode active material; and
the lithium deposition step of charging/discharging the lithium-ion battery to deposit lithium on the negative electrode material.

In addition, the reuse system (the battery processing system) 100 according to the present embodiment is
the battery processing system for processing the lithium-ion battery including the positive electrode material and the negative electrode material, the battery processing system including:
a pressing device that presses at least a portion of the lithium-ion battery; and
a charging/discharging device that charges/discharges the lithium-ion battery.

In the above embodiment, the lithium-ion battery 1 may be of a suitable type. In an implementation, the lithium-ion battery 1 may be of a capacitive type (also referred to as an energy type) rather than a high-output type (also referred to as a power type). In the lithium-ion battery of the capacitive type, density of the negative electrode active material 37 is higher than that in the lithium-ion battery of the high-output type. Accordingly, it is difficult to take out lithium that is deposited in the negative electrode active material 37, for example, between graphite layers. In the method of the present disclosure, since the structure change of the surface of the negative electrode active material is caused to selectively deposit lithium, deposition of lithium between the graphite layers can be reduced. This improves lithium collection efficiency. That is, when the lithium-ion battery 1 is of the capacitive type, operational effects of the embodiments are further suitably achieved.

Here, in the present specification, the lithium-ion battery 1 being of the high-output type means a case where output density thereof is 4000 kW/L or more. Meanwhile, the lithium-ion battery 1 being of the capacitive type means a case where the energy density thereof is 600 Wh/L or more.

In the embodiment described above, the description has been made on, as the example, the case where the structure change step S2 is executed after the lithium-ion battery 1 in the form of the battery pack is provided to the reuse step S1. In the reuse step S1 and/or the structure change step S2, the lithium-ion battery 1 may be subjected in the form of the battery module 4 or the battery cell 3.

### Second Embodiment

A second embodiment differs in that a second structure change step S12 (see FIG. 4) is adopted instead of the structure change step S2 according to the first embodiment. In the second structure change step S12, based on the structure change step S2, the lithium-ion battery 1 is further pressed in the lamination direction A under a predetermined pressing condition during charging.

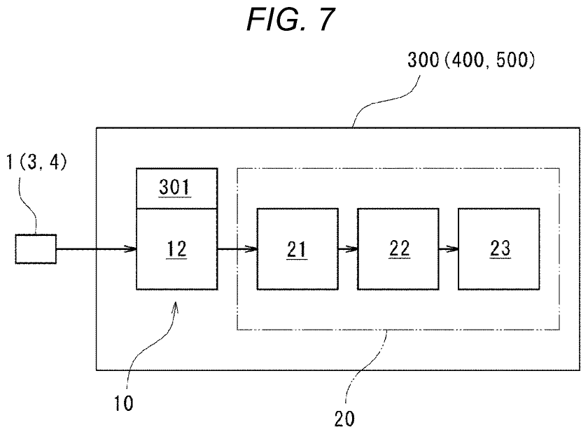

FIG. 7 is a block diagram schematically illustrating a reuse system 300 according to the second embodiment. As illustrated in FIG. 7, the reuse system 300 differs from the reuse system 100 according to the first embodiment in that the lithium-ion battery 1 in the form of the battery cell 3 is provided to the reuse unit 10, and in that the reuse unit 10 includes a pressing device 301 that presses the battery cell 3 in the lamination direction A.

The pressing device 301 is a device that presses the battery cell 3 with a predetermined pressing force in the lamination direction A. In order to generate a charging/discharging reaction in the lithium-ion battery 1, the pressing device 301 may be provided to the lithium-ion battery 1 that has been primarily used in the electric-powered vehicle, or may be provided to the lithium-ion battery 1 that has been secondarily used in the reuse unit 10. Alternatively, a pressing device that can automatically or manually adjust a pressing force may be provided separately.

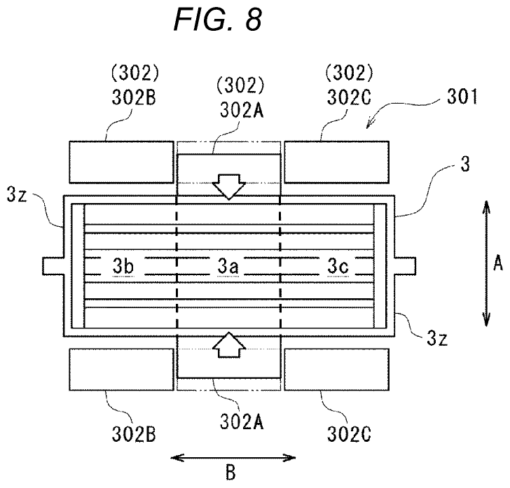

FIG. 8 is a view schematically illustrating the pressing device 301. FIG. 8 schematically illustrates the battery cell 3 that is pressed by the pressing device 301. As illustrated in FIG. 8, the pressing device 301 includes plural sets of presser pairs 302, each set of which is provided as a pair on both sides of the battery cell 3 in the lamination direction A, and which are divided in the width direction B of the battery cell 3. In the present embodiment, there are a central presser pair 302A located at a center in the width direction B, a one-side or first side presser pair 302B located on one side (a left side in FIG. 8) in the width direction B, and an other-side or second side presser pair 302C located on the other side (a right side in FIG. 8) in the width direction B. The number of presser pairs 302 may be three, or may be two, four, or more.

In the second structure change step S12, the battery cell 3 is charged in a state where the battery cell 3 is locally pressed by operating at least some presser pairs 302 of the plural sets of the presser pairs 302. Accordingly, in the second structure change step S12, the battery cell 3 is charged by increasing the pressing force in the lamination direction A on at least a portion thereof to be larger than that on the remaining portion. In the second structure change step S12, the battery cell 3 is pressed with such a pressing force that causes the structure change of the surface of the negative electrode active material at least by the charging/discharging reaction. For example, the pressing force is 10 kPa or more and 1 MPa or less.

As a result, when the lithium-ion battery 1 is charged, the pressing force on at least a portion thereof is increased. In this way, the structure change of the surface of the negative electrode active material can be accelerated in the negative electrode material 35 that corresponds to such a portion. As a result, lithium is easily and locally deposited in the subsequent lithium deposition step. For example, lithium may be deposited on the entire surface of the negative electrode material 35 by charging while sequentially changing the place where the pressing force is increased. Furthermore, by increasing the pressing force in a portion where the electrolytic solution remains, lithium may be efficiently deposited in the portion where the electrolytic solution remains.

“[I]ncreasing the pressing force in the lamination direction A on at least a portion thereof to be larger than that on the remaining portion” also means reducing the pressing force in the remaining portion in a state where the entire battery cell 3 is uniformly pressed. For example, it is included in the second structure change step S12 to partially reduce or release pressing in the lithium-ion battery 1 that is secondarily used in the reuse unit 10, that is, that is entirely and uniformly pressed. As described above, in a case where the second structure change step S12 is executed by using the pressing device provided in the lithium-ion battery 1 that has been secondarily used, compared to a case where a third structure change step S13 is executed by separately attaching the pressing device to the lithium-ion battery 1, it is possible to perform work efficiently without requiring time and effort of attachment.

Here, in the second structure change step S12, the lithium-ion battery 1 only needs to be charged in the pressed state. A pressing step of the lithium-ion battery 1 by the pressing device 301 and charging of the lithium-ion battery 1 by the charging device 12 may be started simultaneously, or one thereof may be started first.

In the lithium extraction step S5, lithium is preferentially extracted from the negative electrode material 35, on which lithium has been locally deposited in the second structure change step S12, of the disassembled negative electrode materials 35. That is, lithium is selectively extracted from the portion of the negative electrode material 35 that corresponds to the portion having been pressed in the second structure change step S12. Which portion of the plural negative electrode materials 35 corresponds to the above-described portion can be visually identified, or can be identified on the basis of the portion that has been pressed in the second structure change step S12. This makes it possible to extract lithium further efficiently.

In the above embodiment, the case where the presser pair 302 is divided in the width direction B of the battery cell 3 has been described as the example. However, it may be divided in a height direction C that is orthogonal to the lamination direction A and the width direction B of the battery cell 3, or may be further divided in both the width direction B and the height direction C.

### Third Embodiment

A third embodiment differs in that the third structure change step S13 (see FIG. 4) is adopted instead of the structure change step S2 according to the first embodiment. In the third structure change step S13, based on the structure change step S2, the battery cell 3 is charged while a central portion thereof in the width direction B and/or the height direction C is pressed in the lamination direction A under a predetermined pressing condition.

With reference to FIG. 7, a reuse system 400 according to the third embodiment includes the pressing device 301 similar to the reuse system 300 according to the second embodiment, and the lithium-ion battery 1 is provided in the form of the battery cell 3 to the reuse unit 10.

In the third structure change step S13, as illustrated in FIG. 8, the battery cell 3 is charged in a state where only a central portion 3a in the width direction B of the battery cell 3 is pressed by operating only the central presser pair 302A, which is located on the central portion of the battery cell 3 in the width direction B and/or the height direction C, among the plural sets of the presser pairs 302. Accordingly, in the third structure change step S13, the battery cell 3 is charged by increasing the pressing force in the lamination direction A on the central portion 3a in a plane perpendicular to the lamination direction A in comparison with the remaining portions 3b, 3c.

For example, in a case where the presser pairs 302 are substantially equally divided into four in the width direction B, only the two inner presser pairs 302 in the width direction B may be operated. Meanwhile, in a case where the presser pairs 302 are arranged to be substantially equally divided into five in the width direction B, only the three inner presser pairs 302 in the width direction B or only the central presser pair 302 in the width direction B may be operated. That is, in the third structure change step S13, a portion, which includes the central portion 3a but does not include a peripheral edge portion 3z, in the battery cell 3 may be pressed.

As a result, in both of the side portions 3b, 3c of the battery cell 3, the electrolytic solution is likely to flow to the outside from the peripheral edge portion 3z and thus to be depleted. Meanwhile, since the central portion 3a is separated from the peripheral edge portion 3z, the electrolytic solution 39 is likely to remain. Thus, by increasing the pressing force in the central portion 3a in which the electrolytic solution 39 is likely to remain, lithium is easily and efficiently deposited on the portion of the negative electrode material 35 corresponding to the central portion 3a as a lithium deposition portion.

Here, in the third structure change step S13, the lithium-ion battery 1 only needs to be charged in the pressed state. A pressing step of the lithium-ion battery 1 by the pressing device 301 and a charging step of the lithium-ion battery 1 by the charging device 12 may be started simultaneously, or one thereof may be started first. That is, after the pressing step by the pressing device 301 is executed, the charging device 12 may execute the charging step while the pressed state by the pressing device 301 is maintained.

### Fourth Embodiment

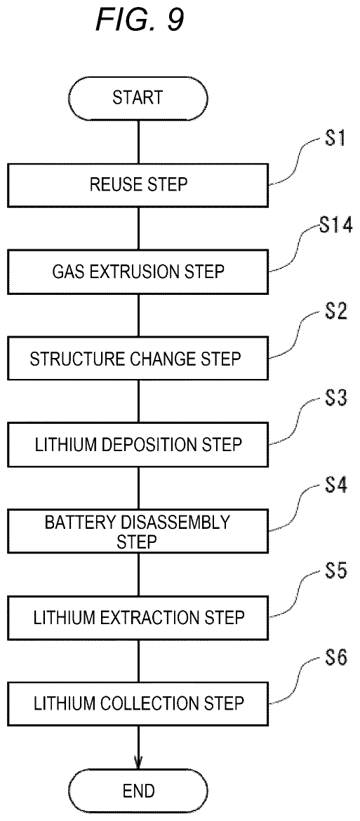

FIG. 9 is a flowchart schematically illustrating a flow of reuse of the lithium-ion battery 1 according to a fourth embodiment. As illustrated in FIG. 9, in the fourth embodiment, a gas extrusion step S14 is executed prior to the structure change step S2. In the gas extrusion step S14, on the assumption that gas is generated inside the lithium-ion battery 1, the gas is pushed toward the peripheral edge portion 3z side of the lithium-ion battery 1 by sequentially pressing it in the lamination direction A under a predetermined pressing condition.

When the gas is generated inside the lithium-ion battery 1, external appearance of the lithium-ion battery 1 expands. Thus, the generation of the gas can be checked by the external appearance of the lithium-ion battery 1. In addition, since a pressure inside the lithium-ion battery 1 fluctuates due to generation of the gas, the generation of the gas can also be checked by the fluctuation of the pressing force by the pressing device 301 described below.

In general, when the gas is generated in the lithium-ion battery 1, transfer of electrons between the positive electrode material 31 and the negative electrode material 35 is inhibited by the gas, and thus the charging/discharging reaction is less likely to occur. The gas is a by-product that is generated from the electrolytic solution 39 as a result of the charging/discharging reaction in the primary use and the secondary use of the lithium-ion battery 1. The gas is methane and/or carbon dioxide, for example.

With reference to FIG. 7, a reuse system 500 according to the fourth embodiment includes the pressing device 301 similar to the reuse system 300 according to the second embodiment, and the lithium-ion battery 1 is provided in the form of the battery cell 3 to the reuse unit 10.

In the gas extrusion step S14, the gas generated in the battery cell 3 is extruded to the peripheral edge portion 3z side by sequentially operating the presser pairs 302 in the plural sets of the presser pairs 302 from the one end portion 3b side to the other end portion 3c side in the width direction B or by sequentially operating them from the central portion 3a in the width direction B to both of the side portions 3b, 3c side in the width direction B. Accordingly, when the gas is generated in the battery cell 3, the gas extrusion step is further provided to extrude the gas toward the peripheral edge portion 3z of the negative electrode material 35 in an in-plane direction perpendicular to the lamination direction A prior to the structure change step S2.

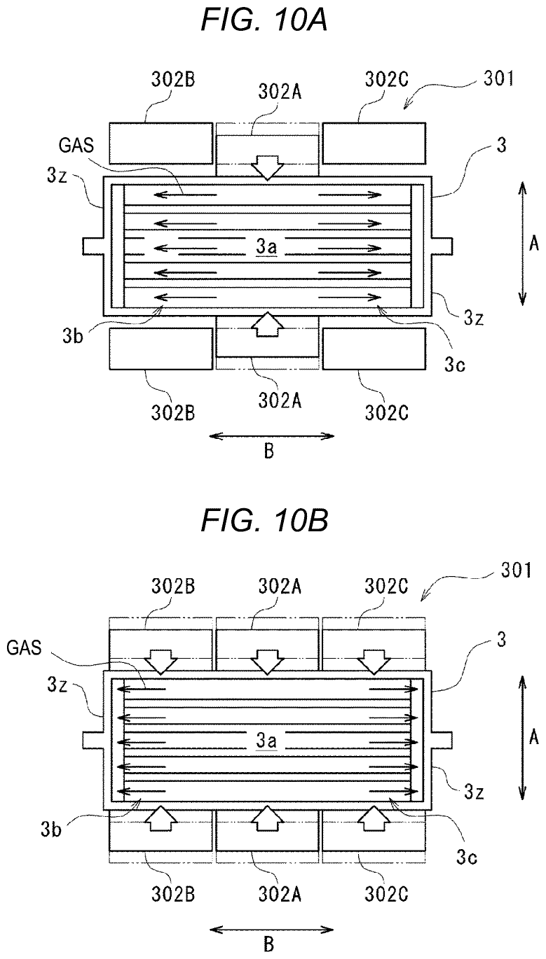

For example, as illustrated in FIG. 10A, after the central portion 3a of the battery cell 3 in the width direction B is first pressed, both of the side portions 3b, 3c in the width direction B may be additionally pressed as illustrated in FIG. 10B. As a result, the gas is extruded from the central portion 3a side in the width direction B of the battery cell 3 toward both of the side portions 3b, 3c. Here, each of the portions 3a, 3b, 3c of the battery cell 3 remains to be pressed in the manner to prevent the flow of the extruded gas toward the central portion 3a or the like of the battery cell 3 again.

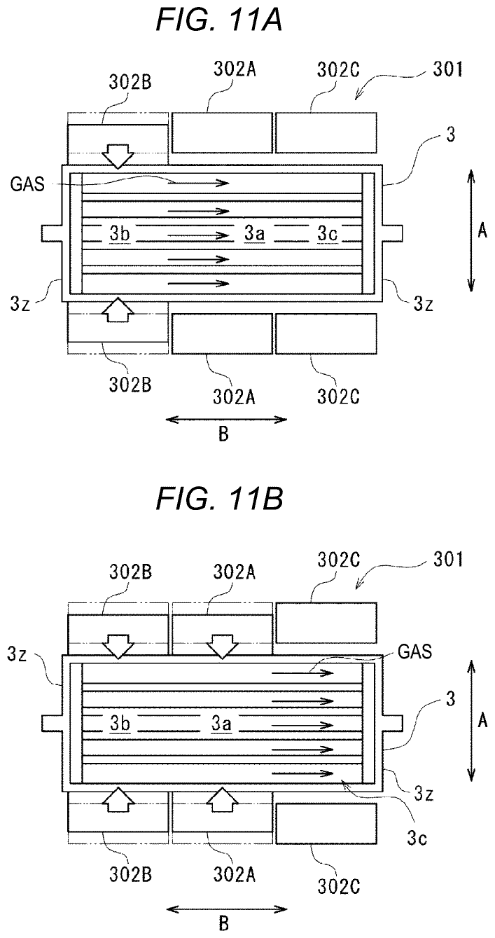

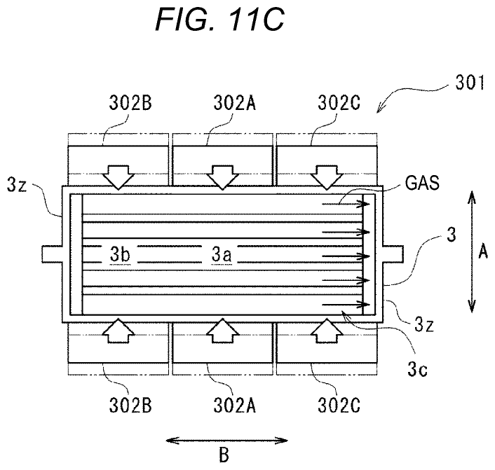

Furthermore, as illustrated in FIG. 11A, after pressing the one end portion 3b in the width direction B of the battery cell 3, the central portion 3a in the width direction may be additionally pressed as illustrated in FIG. 11B, and the other end portion 3c in the width direction B may be further additionally pressed as illustrated in FIG. 11C. As a result, the gas is extruded from the one end portion 3b side to the other end portion 3c side in the width direction B. Here, each of the portions 3a, 3b, 3c of the battery cell 3 may remain pressed in the manner to prevent the flow of the extruded gas toward the central portion 3a or the like of the battery cell 3 again.

As a result, the electrolytic solution 39 is easily distributed around the negative electrode material 35 by extruding the gas toward the peripheral edge portion 3z. As a result, even in a case of the battery cell 3 in which the gas is generated, the charging reaction in the negative electrode material 35 can be generated. Thus, even in the battery cell 3 in which the gas is generated, the structure change of the surface of the negative electrolyte can be accelerated by charging in a locally pressed state. As a result, lithium is easily deposited on the portion, in which the structure change of the surface of the negative electrode active material is accelerated, in the negative electrode material 35.

In the second to the fourth embodiments described above, the description has been made on, as the example, the case where the structure change step is executed after the lithium-ion battery 1 in the form of the battery cell 3 is provided to the reuse step S1. The lithium-ion battery 1 in the form of the battery pack or the battery module 4 may be provided to the reuse step S1 and/or the lithium deposition step. In this case, the pressing device 301 may be built in the battery pack or the battery module 4 in advance.

The reuse system of the lithium-ion battery 1 according to the present disclosure may correspond to the configurations described in the above embodiments, and various modifications can be made thereto.

In the above embodiment, the description has been made on the example in which the lithium-ion battery is of the laminated type. For example, a lithium-ion battery in a cylindrical shape or a polygonal shape may be adopted, the lithium-ion battery being formed by winding a belt-shaped laminated electrode body, in which a belt-shaped positive electrode material, a belt-shaped separator, and a belt-shaped negative electrode material are laminated in the lamination direction A, in a cylindrical shape or a polygonal shape. In a case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In a case of the implementation on the battery pack-by-battery pack basis, the pressing device, the cooling device, and the like may be provided in the battery pack in advance.

### Additional Remarks

According to the present disclosure, the following aspects are provided.

### First Aspect

The battery processing method for processing the lithium-ion battery including the positive electrode material and the negative electrode material and configured by laminating the positive electrode material and the negative electrode material in the lamination direction, the battery processing method including:
the structure change step of charging/discharging the lithium-ion battery to cause the structure change of the surface of the negative electrode active material; and
the lithium deposition step of charging/discharging the lithium-ion battery to deposit lithium on the negative electrode material.

### Second Aspect

The battery processing method according to the first aspect, in which, in the structure change step, the charging current is applied while the negative electrode material is pressed.

### Third Aspect

The battery processing method according to the first or second aspect, in which, in the structure change step, charging/discharging is performed by the pulse charging in which the charging phase and the charging pause phase are alternately performed.

### Fourth Aspect

The battery processing method according to any one of the first to third aspects further including: the gas extrusion step of extruding the gas inside the lithium-ion battery from the central portion to the peripheral edge portion in the plane perpendicular to the lamination direction of the negative electrode material prior to the structure change step.

### Fifth Aspect

The battery processing method according to any one of the first to fourth aspects, in which, in the lithium deposition step, charging/discharging is performed by the pulse charging in which the charging phase and the charging pause phase are alternately performed.

### Sixth Aspect

The battery processing method according to any one of the first to fifth aspects designed for the lithium-ion battery, energy density of which is 600 Wh/L or more.

### Seventh Aspect

The battery processing method according to any one of the first to sixth aspects further including: the lithium extraction step of extracting lithium from the negative electrode material after the lithium deposition step.

### Eighth Aspect

The battery processing method according to any one of the first to seventh aspects further including: the lithium collection step after the lithium extraction step, in the lithium collection step, the extracted lithium being mixed with carbonated water, which is then filtered, to collect it as lithium carbonate.

### Ninth Aspect

The battery processing system for processing the lithium-ion battery including the positive electrode material and the negative electrode material, the battery processing system including:
the pressing device that presses at least a portion of the lithium-ion battery; and
the charging/discharging device that charges/discharges the lithium-ion battery.

### REFERENCE SIGNS LIST

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
100: reuse system
201: cooling device
301: pressing device

1. A battery processing method for processing a lithium-ion battery including a positive electrode material and a negative electrode material and configured by laminating the positive electrode material and the negative electrode material in a lamination direction, the battery processing method comprising:
a structure change step of charging/discharging the lithium-ion battery to cause a structure change of a surface of a negative electrode active material; and
a lithium deposition step of charging/discharging the lithium-ion battery to deposit lithium on the negative electrode material.

2. The battery processing method according to claim 1, wherein, in the structure change step, a charging current is applied while the negative electrode material is pressed.

3. The battery processing method according to claim 1, wherein, in the structure change step, charging/discharging is performed by pulse charging in which a charging phase and a charging pause phase are alternately performed.

4. The battery processing method according to claim 1, further comprising a gas extrusion step of extruding gas inside the lithium-ion battery from a central portion to a peripheral edge portion in a plane perpendicular to the lamination direction of the negative electrode material prior to the structure change step.

5. The battery processing method according to claim 4, wherein the gas extrusion step includes extruding the gas with a gas extrusion device that presses the lithium-ion battery with a predetermined pressing force in the lamination direction.

6. The battery processing method according to claim 5, wherein the gas extrusion device includes a plurality of presser pairs, each presser pair is on opposite sides of the lithium-ion battery in the lamination direction, and each presser pair is divided in a width direction of the lithium-ion battery.

7. The battery processing method according to claim 6, wherein the plurality of presser pairs includes a central presser pair located at a center in the width direction of the lithium-ion battery; a first side presser pair located on one side of the lithium-ion battery in the width direction; and a second side presser pair located on another side of the lithium-ion battery in the width direction of the lithium-ion battery.

8. The battery processing method according to claim 1, wherein, in the lithium deposition step, charging/discharging is performed by pulse charging in which a charging phase and a charging pause phase are alternately performed.

9. The battery processing method according to claim 1, wherein the lithium-ion battery has an energy density of 600 Wh/L or more.

10. The battery processing method according to claim 1, further comprising a lithium extraction step of extracting lithium from the negative electrode material after the lithium deposition step.

11. The battery processing method according to claim 1, further comprising a lithium collection step after the lithium extraction step, wherein the lithium collection step includes mixing the extracted lithium with carbonated water and then filtering to collect lithium in the form of lithium carbonate.

12. A battery processing system for processing a lithium-ion battery including a positive electrode material and a negative electrode material, the battery processing system comprising:
a pressing device that presses at least a portion of the lithium-ion battery; and
a charging/discharging device that charges/discharges the lithium-ion battery.

13. The battery processing system according to claim 12, wherein the pressing device includes a plurality of presser pairs, each presser pair being on opposite sides of the lithium-ion battery in a lamination direction of the lithium-ion battery, and each presser pair is divided in a width direction of the lithium-ion battery.

14. The battery processing system according to claim 13, wherein the plurality of presser pairs includes a central presser pair located at a center in the width direction of the lithium-ion battery; a first side presser pair located on one side of the lithium-ion battery in the width direction; and a second side presser pair located on another side of the lithium-ion battery in the width direction of the lithium-ion battery.
